(19) United States
(12) Patent Application Publication
(10) Pub. No.: US 2009/0233258 A1
(43) Pub. Date: Sep. 17, 2009

(54) Method for Producing a Tooth Replacement Having a Multi-Layer Structure

(76) Inventors: Ralph Gunnar Luthardt, Dresden (DE); Martina Johannes, Hermsdorf (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 12/084,532

(22) PCT Filed: Oct. 26, 2006
(86) PCT No.: PCT/DE2006/001899

§ 371 Date: Aug. 18, 2008

(51) Int. Cl. A61C 5/10; A61C 13/34

(52) U.S. Cl. 433/223; 433/213

(57) ABSTRACT

The invention is directed to a method for the production of an individual tooth replacement formed of multiple layers, for example, a removable tooth replacement, implant superstructures, bridges, crowns, partial crowns, onlays and inlays. According to the invention, this object is met by a method for producing a tooth replacement formed of multiple layers in that a CAD data set of the tooth replacement to be produced is initially made by digitizing the teeth which are already prepared and their immediate surroundings into which the tooth replacement is to be inserted, in that a first CAD partial data set and a second CAD partial data set are determined from this CAD data set, the first CAD partial data set representing the supporting framework structure of the tooth replacement and the second CAD partial data set representing the aesthetically and/or functionally relevant outer geometry of the tooth replacement which faces predominantly toward the oral cavity, in that the supporting framework structure is then produced by the first CAD partial data set, and the supporting framework structure for the multilayer tooth replacement is then finished using the second CAD partial data set by applying a functional layer, for example, in the form of a ceramic veneer or a polymer facing the mucous membrane.

### CROSS-REFERENCE TO RELATED APPLICATIONS

This is a national phase application of International Application No. PCT/DE2006/001899, filed Oct. 26, 2006 which claims priority of German Application No. 10 2005 052 838.4, filed Nov. 3, 2005, the complete disclosures of which are hereby incorporated by reference.

### BACKGROUND OF THE INVENTION

a) Field of the Invention

The invention is directed to a method for the production of an individual tooth replacement formed of multiple layers, for example, a removable tooth replacement, a tooth replacement supported by an implant, including the implants, implant superstructures, bridges, crowns, partial crowns, onlays and inlays.

b) Description of the Related Art

In caring for patients having individual teeth that have been largely destroyed, individual crowns are used. For this purpose, the teeth are prepared by the dentist in such a way that abutment teeth are formed. The missing tooth material is replaced by the artificial crown. If individual teeth are damaged to the extent that they must be removed, implants (artificial tooth roots) which are anchored in the alveolar bone are used. Prefabricated conical superstructure parts having a shape comparable to that of the prepared tooth stumps are mounted on these implants. Alternatively, teeth in front of and/or behind the missing tooth or teeth are prepared in the manner described above. Intermediate bridge elements are inserted in the area of the missing teeth to replace these teeth.

In all of these situations, the dentist makes an impression of the dental configuration. This negative impression is converted into a positive object (model) by the dental technician. This model is used by the dental technician to manufacture the tooth replacement in a manual production process. For this purpose, metals, ceramics and polymers are processed individually or as a composite. After the dentist has inspected the tooth replacement in the patient's mouth with respect to appearance, accuracy of fit, and proper functioning in relation to the adjoining tissue (mucous membrane, cheek, antagonistic teeth, neighboring teeth), the tooth replacement is definitively fastened to the prepared tooth stumps.

Alternatively, the tooth replacement can also be produced by CAD/CAM methods. The required measurement data for the reverse engineering process are obtained through optical or mechanical digitization in the patient's mouth (intraorally) or on the basis of the model (extraorally). The shape of the tooth replacement is then formed in the computer, followed by production through subtractive (grinding, cutting) or additive (pressing, casting, laser sintering) methods.

Regardless of the method of producing the tooth replacement (conventional, CAD/CAM), different materials are combined (ceramic on metal, polymers on metal, ceramic on ceramic) for aesthetic reasons. The materials used for the surface structuring are predominantly selected on aesthetic grounds but have disadvantages with respect to mechanical characteristics.

A removable tooth replacement is anchored in the remaining tooth material by retaining elements (e.g., clasps, attachments) and, for this reason, it is compulsory that its framework structure be produced from materials with correspondingly adapted elastic properties. The reason for this is that the retaining elements bend elastically, for example, from insertion until the point that the prosthetic equator is reached. The removable tooth replacement is securely fixed to the residual tooth material below this prosthetic equator, i.e., when the clasps flex back elastically. When the tooth replacement is removed, the clasps bend elastically again and must then be restored without deformation. Material characteristics such as these can be achieved by metal materials as well as polymers, but ceramic materials so far seem to be unsuitable for this purpose. Ceramic materials have so far been used only for short span and not for long span bridges, even for tightly fitting tooth replacements

The structuring of a multi-layer tooth replacement is carried out empirically regardless of the production method. A structuring of the tooth replacement specifically geared toward mechanical, aesthetic and functional requirements with a corresponding construction of the individual portions of the composite body (high-strength framework, cosmetic veneer) has so far been unsuccessful.

### OBJECT AND SUMMARY OF THE INVENTION

It is the primary object of the invention to provide a method which makes it possible to produce an aesthetic multi-layer tooth replacement, particularly a removable tooth replacement, implant-supported tooth replacement, including the implants, implant superstructures, bridges, crowns, onlays, and inlays, without costly manual work.

According to the invention, this object is met by a method for producing a tooth replacement formed of multiple layers in that a CAD data set of the tooth replacement to be produced is initially made from the digitized measurement data of the teeth which are already prepared or of the implants and their immediate surroundings into which the tooth replacement is to be inserted, in that a first CAD partial data set and a second CAD partial data set are determined from this CAD data set, the first CAD partial data set generally representing the supporting framework structure of the tooth replacement and the second CAD partial data set representing the aesthetically and/or functionally relevant outer geometry of the tooth replacement primarily directed toward the oral cavity, in that the supporting framework structure is then produced by means of the first CAD partial data set, and the supporting framework structure for the multilayer tooth replacement is then finished using the second CAD partial data set by applying a functional layer, for example, in the form of a ceramic veneer or a polymer facing the mucous membrane. The CAD data set can be produced intraorally or can be produced extraorally from jaw models or partial models. The supporting framework structure is advantageously produced from metallic and/or ceramic materials and/or polymers. It may be advantageous when the second CAD partial data set is divided into a plurality of CAD partial data sets so as to make it possible to produce molds having multiple parts with a separating line in the area of the largest circumference. With regard to bridges, crowns, partial crowns or inlays, it is advantageous when the functional layer serving as a veneer, for example, the ceramic veneer, is formed with the inclusion of the restoration edge. In order to make it possible to reproduce physiological, natural occlusal surfaces with a corresponding fissure depth, it has proven advantageous when the functional layer serving as a veneer is produced from ceramic materials or polymers by additive processes, for example, hot-pressing, die casting or slip casting.

The invention will be described more fully in the following with reference to embodiment examples.

### DESCRIPTION OF THE PREFERRED EMBODIMENTS

First, measurements data of the abutment teeth which have already been prepared for receiving the tooth replacement, the adjoining tissue, the neighboring teeth, and antagonistic teeth are determined and form the foundation of the CAD data set. The measurement data can be compiled intraorally or extraorally from jaw models or partial models or existing semifinished products (implant components, bridge frameworks). The CAD data set derived from the latter represents the tooth replacement to be produced as a closed volume form. Aesthetic, functional and mechanical aspects must be taken into account when producing the tooth replacement. On this basis, portions which must be made of mechanically strong materials, those which must be produced from materials with functional advantages, and those which must be produced from materials with aesthetic advantages are calculated. The production of the tooth replacement is carried out by CAM manufacture of hollow molds in which the portions of the tooth replacement with the highest processing temperatures are produced first. Afterward, molds are made for adding the portions of materials with low processing temperatures. In doing so, the portions of the tooth replacement that have already been produced in previous process steps and which take into account either aesthetic requirements, functional requirements or mechanical requirements form portions of the mold. Therefore, according to the invention, the CAD data set is divided into at least two CAD partial data sets. The first CAD partial data set represents the interior of the multi-layer tooth replacement, and the second CAD partial data set represents the exterior portion of the tooth replacement. Accordingly, a high-strength bridge framework of metal which is shaped with a view to mechanical aspects can be formed first by means of the first CAD partial data set and a suitable shaping process. The high-strength bridge framework is then supplemented by a cosmetic ceramic veneer, wherein materials with different sinter shrinkage are applied.

A tooth replacement which is produced by conventional methods (e.g., cast bridge framework) or by subtractive methods (grinding, cutting) can also be further processed through the compilation of the first CAD partial data set. The second CAD partial data set which is subdivided into additional partial data sets was prepared for the aesthetic and/or functional veneer.

Alternatively, the production of the hollow molds can be carried out by additive methods such as stereo lithography or sequential application with subsequent sintering, or the shaping of individual portions of the tooth replacement can be realized by additive methods such as stereo lithography or sequential application of metal or ceramic with subsequent sintering,

A removable tooth replacement can be produced in a particularly simple and efficient manner by means of the present invention from ceramic, metallic and polymer materials in that, for example, cosmetic veneering is subsequently added to a metallic framework to which prosthetic saddles made from polymers are added in turn. This is achieved in that the CAD data set that has already been compiled can be broken down into any number of partial data sets taking into account the functional task of the partial area of a multi-layer tooth replacement. This means, for example, that a partial area will take into account only aesthetic aspects.

When the prefabricated parts are used on implants, molds containing the prefabricated portions as a component of the mold can be produced in quantity. In this case, in the simplest instance, only the individual portion of the mold for the respective patient is produced. The first CAD partial data set would then correspond to the prefabricated part. However, it would also conceivable to divide the first CAD partial data set yet again and one partial data set would then represent the individual portion.

In a preparatory step, the prefabricated portion could be reduced by a subtractive method to give it the shape of the first CAD partial data set and could then be supplemented subsequently in one or more steps by portions that must be made of mechanically strong materials or that must be produced from materials with functional advantages or aesthetic advantages.

While the foregoing description and drawings represent the present invention, it will be obvious to those skilled in the art that various changes may be made therein without departing from the true spirit and scope of the present invention.

1-14. (canceled)

15. A method for producing a tooth replacement formed of multiple layers comprising the steps of:
initially compiling a CAD data set of the tooth replacement from a digitized measurement data of the prepared teeth or of the implants and their immediate surroundings into which the tooth replacement is to be inserted;
compiling a first CAD partial data set and a second CAD partial data set, wherein the first CAD partial data set represents the supporting framework structure of the tooth replacement, and the second CAD partial data set represents the aesthetically and/or functionally relevant outer geometry of the tooth replacement which faces predominantly toward the oral cavity;
producing the supporting framework structure by the first CAD partial data set; and
finishing the supporting framework structure for the multilayer tooth replacement using the second CAD partial data set by applying a functional layer.

16. The method according to claim 15, wherein the CAD data set is produced intraorally or is produced extraorally from jaw models or partial models.

17. The method according to claim 15, wherein the supporting framework structure is produced from metallic and/or ceramic materials and/or polymers.

18. The method according to claim 15, wherein the functional layer is produced in method steps comprising multiple steps from materials with different mechanical, visual or aesthetic properties.

19. The method according to claim 15, wherein the second CAD partial data set is divided into a plurality of CAD partial data sets so as to make it possible to produce molds having multiple parts with a separating line in the area of the largest circumference.

20. The method according to claim 15, wherein the functional layer is formed with the inclusion of the restoration edge in bridges, crowns, partial crowns or inlays.

21. The method according to claim 15, wherein the functional layer of ceramic materials or polymers is processed by slip casting in order to make it possible to reproduce physiological, natural occlusal surfaces with a corresponding fissure depth.

22. The method according to claim 15, wherein the functional layer is produced by injection molding.

23. The method according to claim 15, wherein the functional layer is produced by die casting.

24. The method according to claim 15, wherein the ceramic materials and/or the polymers are pressed in the mold with overpressure to produce the functional layer.

25. The method according to claim 15, wherein the mold is filled with the ceramic materials and/or the polymers while applying vacuum pressure.

26. The method according to claim 15, wherein the first CAD partial data set is divided into additional partial data sets.

27. The method according to claim 15, wherein the second CAD partial data set is divided into additional partial data sets.

28. The method according to claim 15, wherein the supporting framework structure is produced with knowledge of the first CAD partial data set on the basis of a tooth replacement produced by conventional methods.
